(19) United States
(12) Patent Application Publication
(10) Pub. No.: US 2024/0377823 A1
(43) Pub. Date: Nov. 14, 2024

(54) GAME THEORIC PATH PLANNING FOR SOCIAL NAVIGATION

(71) Applicants: Honda Motor Co., Ltd., Tokyo (JP); Northwestern University, Evanston, IL (US)

(72) Inventors: Muchen SUN, Evanston, IL (US); Francesca BALDINI, San Jose, CA (US); Peter F. TRAUTMAN, Pebble Beach, CA (US); Todd David MURPHEY, Evanston, IL (US)

(21) Appl. No.: 18/316,856

(22) Filed: May 12, 2023

(51) Int. Cl. G05D 1/00; G05D 1/02; G06N 7/01

(52) U.S. Cl. CPC G05D 1/0088; G06N 7/01

(57) ABSTRACT

Systems and methods for game theoric path planning for social navigation are provided. In one embodiment, a method includes identifying a set of dynamic agents in an agent environment based on sensor data from one or more agent sensors of an ego agent. The method includes determining preference distributions for dynamic agent of the set of dynamic agents. The method includes determining a joint state for the dynamic agents of the set of dynamic agents by applying a recursive model to each dynamic agent to calculate a trajectory likelihood based on an expected interference risk of a candidate trajectory and the preference distributions. The joint state for the set of dynamic agents minimizes deviations from the goal state for each dynamic agent and minimizes the expected interference risk. The method includes causing the ego agent to execute a path plan based on the joint state for the dynamic agents.

### BACKGROUND

For robots navigating in human-occupied spaces, robots engage in joint navigation between the robot and humans, such as whether and how humans will make space for the robot to pass. Misjudgment of human-human and human-robot joint navigation strategies may lead to aggressive behavior, where the robot wrongly expects humans to make space for the robot, or over-conservative behavior, where the robot wrongly believes there is no viable path forward, while humans are actually willing to make space for the robot. The problem of inferring multi-agent cooperative interference avoidance strategies as social navigation.

### BRIEF DESCRIPTION

According to one embodiment, a computer-implemented method for game theoric path planning for social navigation is provided. The computer-implemented method includes identifying a set of dynamic agents in an agent environment based on sensor data from one or more agent sensors of an ego agent. The computer-implemented method also includes determining preference distributions for each dynamic agent of the set of dynamic agents. A preference distribution for a dynamic agent of the set of dynamic agents is a probability distribution of a set of candidate trajectories to a goal state that do not account for agent interference of other dynamic agents of the set of dynamic agents. The computer-implemented method further includes determining a joint state for the dynamic agents of the set of dynamic agents by applying a recursive model to each dynamic agent to calculate a trajectory likelihood based on an expected interference risk of a candidate trajectory. The joint state for the set of dynamic agents minimizes deviations from the goal state for each dynamic agent and minimizes the expected interference risk. The computer-implemented method yet further includes causing the ego agent to execute a path plan based on the joint state for the dynamic agents.

According to another embodiment, a system for game theoric path planning for social navigation is provided. The system includes a processor and a memory storing instructions that when executed by the processor cause the processor to identify a set of dynamic agents in an agent environment based on sensor data from one or more agent sensors of an ego agent. The instructions also cause the processor to determine preference distributions for each dynamic agent of the set of dynamic agents. A preference distribution for a dynamic agent of the set of dynamic agents is a probability distribution of a set of candidate trajectories to a goal state that do not account for agent interference of other dynamic agents of the set of dynamic agents. The instructions further cause the processor to determine a joint state for the dynamic agents of the set of dynamic agents by applying a recursive model to each dynamic agent to calculate a trajectory likelihood based on an expected interference risk of a candidate trajectory. The joint state for the set of dynamic agents minimizes deviations from the goal state for each dynamic agent and minimizes the expected interference risk. The instructions yet further cause the processor to cause the ego agent to execute a path plan based on the joint state for the dynamic agents.

According to yet another embodiment, a non-transitory computer readable storage medium storing instructions that, when executed by a computer having a processor, cause the computer to perform a method for game theoric path planning for social navigation is provided. The method includes identifying a set of dynamic agents in an agent environment based on sensor data from one or more agent sensors of an ego agent. The method also includes determining preference distributions for each dynamic agent of the set of dynamic agents. A preference distribution for a dynamic agent of the set of dynamic agents is a probability distribution of a set of candidate trajectories to a goal state that do not account for agent interference of other dynamic agents of the set of dynamic agents. The method further includes determining a joint state for the dynamic agents of the set of dynamic agents by applying a recursive model to each dynamic agent to calculate a trajectory likelihood based on an expected interference risk of a candidate trajectory. The joint state for the set of dynamic agents minimizes deviations from the goal state for each dynamic agent and minimizes the expected interference risk. The method yet further includes causing the ego agent to execute a path plan based on the joint state for the dynamic agents.

### BRIEF DESCRIPTION OF THE DRAWINGS

FIG. 1 is an exemplary component diagram of a system for game theoric path planning for social navigation, according to one aspect.

FIG. 2 is an exemplary agent environment of a system for game theoric path planning for social navigation, according to one aspect.

FIG. 3 is an exemplary process flow of a method for game theoric path planning for social navigation, according to one aspect.

FIG. 4 is an exemplary staging diagram for modeling of game theoric path planning for social navigation with respect to two agents, according to one aspect.

FIG. 5 is an illustration of an example computer-readable medium or computer-readable device including processor-executable instructions configured to embody one or more of the provisions set forth herein, according to one aspect.

### DETAILED DESCRIPTION

As discussed above, misjudgment of agent interactions, including human-human joint navigation strategies and human-robot joint navigation strategies may lead to confusion and interference between agents. For example, between humans and other biological agents, navigation strategies may be determined through mutual observations of other agents, instead of explicit communication such as verbal signals or hand gestures. The lack of explicit communication introduces uncertainty for robotic agents. For robotic agents, navigation strategies may be made in response to the probabilistic beliefs of other agents' intended paths. Accordingly, the systems and methods described herein model agent decision making in the space of probabilities, in order to capture the inherent uncertainty in the social navigation.

In particular, the systems and methods herein utilize a conditional likelihood function to compute a posterior of one agent's intended path, in response to beliefs of other agents' intended paths, by iteratively applying a recursive model across each agent identified in an agent environment. Each agent's navigation strategy is a probability distribution of future paths. In some embodiments, the recursive model is Bayesian belief updating scheme. The iterative Bayesian updating scheme converges to a Nash equilibrium of the game, named as Bayes' rule Nash equilibrium (BRNE), with lower-bounded decrease in the expected interference risk among agents. The systems and methods described herein differ from existing deterministic or probabilistic game theory models for human-human and human-robot physical interaction, because the system and methods herein directly model probabilistic belief as the agent strategy and derive the Nash equilibrium in forms of probabilistic beliefs. The existing deterministic or probabilistic game theory models assume agents have deterministic strategy.

Here, modeling choice exposes belief propagation during the bargaining process, providing insights on the convergence of probabilistic opinions. The recursive model also has an explicit bargaining structure, versus the general game formula in existing models. This bargaining structure enables efficient computation of Nash equilibrium with less processing power. For example, the recursive model achieves real-time inference of Nash equilibrium for up to ten agents on a laptop computer processing unit (CPU). Accordingly, the recursive model, as a Bayesian updating scheme, models cooperative bargaining in social navigation with no explicit communication between the agents.

Additionally, an uncertainty quantification method to characterize prior beliefs for the recursive model. Temporal correlation is extracted from offline trajectory datasets and this information may be used to optimize a temporal Gaussian process as the prior belief. The combination of the uncertainty quantification and the recursive model provides an end-to-end data-driven Nash equilibrium inference model for social navigation for various number of agents and agent environments with reduced processing requirements and improved efficiency.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Agent” as used herein is a self-propelled machine that moves through or manipulates an environment. Exemplary agents may include, but is not limited to, robots, vehicles, or other self-propelled machines. The agent may be autonomously, semi-autonomously, or manually operated.

“Agent system,” as used herein may include, but is not limited to, any automatic or manual systems that may be used to enhance the agent, propulsion, and/or operation. Exemplary systems include, but are not limited to: an electronic stability control system, an anti-lock brake system, a brake assist system, an automatic brake prefill system, a low speed follow system, a cruise control system, a warning system, a mitigation braking system, an auto cruise control system, a lane departure warning system, a blind spot indicator system, a lane keep assist system, a navigation system, a steering system, a transmission system, brake pedal systems, an electronic power steering system, visual devices (e.g., camera systems, proximity sensor systems), an electronic pretensioning system, a monitoring system, a passenger detection system, a suspension system, a seat configuration system, a cabin lighting system, an audio system, a sensory system, an interior or exterior camera system among others.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a bus that interconnects components inside an agent using protocols such as Media Oriented Systems Transport (MOST), Controller Area network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein may include input and/or output devices for receiving input and/or devices for outputting data. The input and/or output may be for controlling different agent features, which include various agent components, systems, and subsystems. Specifically, the term “input device” includes, but is not limited to: keyboard, microphones, pointing and selection devices, cameras, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

“Vehicle,” as used herein, refers to any moving vehicle that is capable of carrying one or more users and is powered by any form of energy. The term “vehicle” includes, but is not limited to cars, trucks, vans, minivans, SUVs, motorcycles, scooters, boats, go-karts, amusement ride cars, rail transport, personal watercraft, and aircraft. In some cases, a motor vehicle includes one or more engines. Further, the term “vehicle” may refer to an electric vehicle (EV) that is powered entirely or partially by one or more electric motors powered by an electric battery. The term “vehicle” may also refer to an autonomous vehicle and/or self-driving vehicle powered by any form of energy.

### I. System Overview

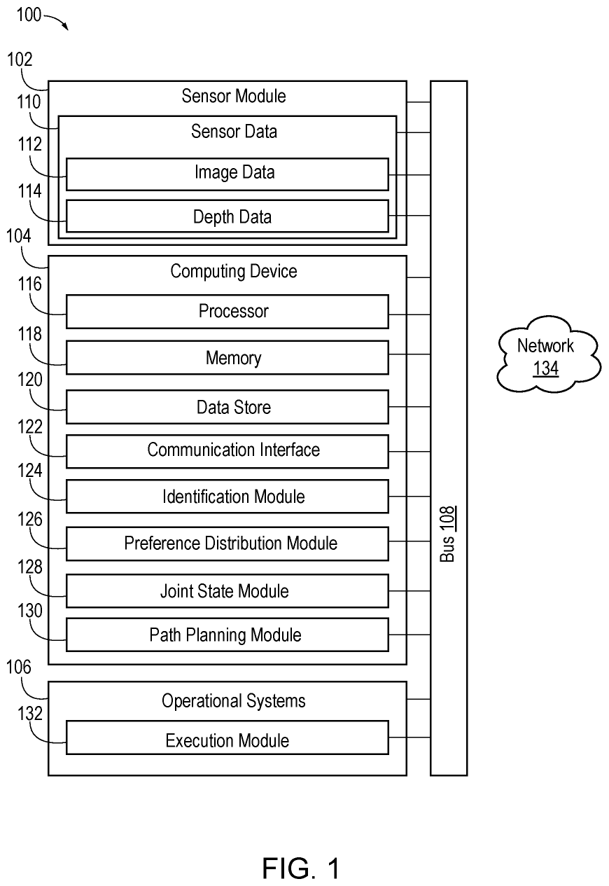

Referring now to the drawings, the drawings are for purposes of illustrating one or more exemplary embodiments and not for purposes of limiting the same. FIG. 1 is an exemplary component diagram of an operating environment 100 for game theoric path planning for social navigation, according to one aspect. The operating environment 100 includes a sensor module 102, a computing device 104, and operational systems 106 interconnected by a bus 108. The components of the operating environment 100, as well as the components of other systems, hardware architectures, and software architectures discussed herein, may be combined, omitted, or organized into different architectures for various embodiments. The computing device 104 may be implemented with a device or remotely stored.

The computing device may be implemented as a part of an agent. The agent may be bipedal, two-wheeled, four-wheeled robot, vehicle, or self-propelled machine. The autonomous ego agent may be configured as a humanoid robot. The humanoid robot may take the form of all or a portion of a robot. For example, the humanoid robot may take the form of an arm with fingers. The computing device 104 may be implemented as part of a telematics unit, a head unit, a navigation unit, an infotainment unit, an electronic control unit, among others of an agent. In other embodiments, the components and functions of the computing device 104 may be implemented, for example, with other devices (e.g., a portable device) or another device connected via a network (e.g., a network 134). The computing device 104 may be capable of providing wired or wireless computer communications utilizing various protocols to send/receive electronic signals internally to/from components of the operating environment 100. Additionally, the computing device 104 may be operably connected for internal computer communication via the bus 108 (e.g., a Controller Area Network (CAN) or a Local Interconnect Network (LIN) protocol bus) to facilitate data input and output between the computing device 104 and the components of the operating environment 100.

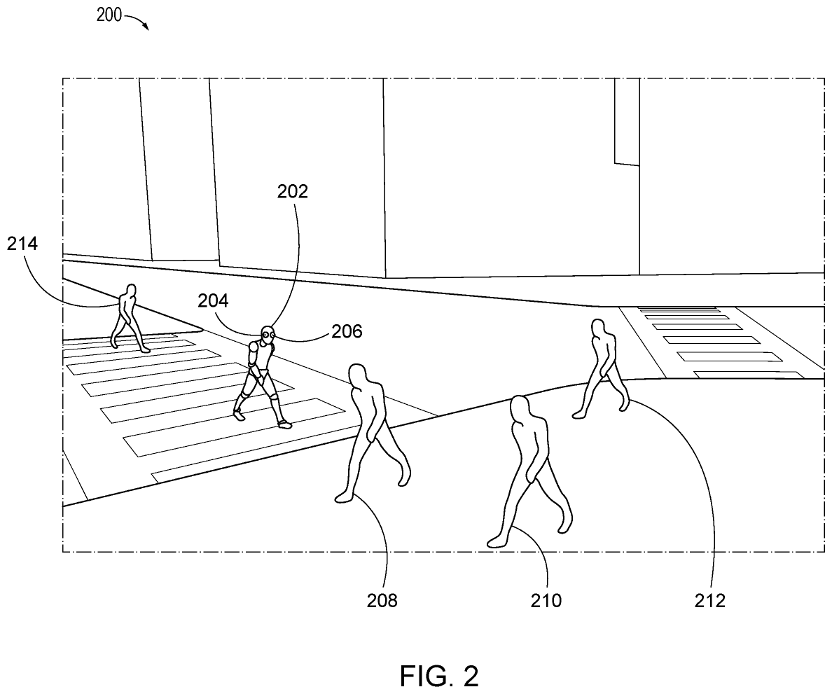

In some embodiments, the ego agent may be the agent 202 shown in the agent environment 200 of FIG. 2. The ego agent 202 has a number of sensors. For example, the ego agent 202 may include a first optical sensor 204 and a second optical sensor 206. The first optical sensor 204 and the second optical sensor 206 receive data from an environment of an objects in the agent environment, such as a first agent 208 and a second agent 210. The sensor module 102 receives, provides, and/or senses information associated with the ego agent 202, the first agent 208, the second agent 210, the operating environment 100, the agent environment 200 of the ego agent 202, and/or the operational systems 106. In one embodiment, the sensor module 102 receives sensor data 110, such as one or more of image data 112 and/or depth data 114 from the sensors. For example, the sensor module 102 may receive image data 112 from the first optical sensor 204 and/or depth data 114 from the second optical sensor 206. The computing device 104 receives the image data 112 and/or the depth data 114 from the sensor module 102. Therefore, the image data 112 and/or the depth data 114 is sensor data 110 received from their respective sensors.

The first optical sensor 204, the second optical sensor 206, and/or the sensor module 102 are operable to sense a measurement of data associated with the ego agent 202, the operating environment 100, objects such as the first agent 208 and the second agent 210, the agent environment 200, and/or the operational systems 106 and generate a data signal indicating said measurement of data. These data signals may be converted into other data formats (e.g., numerical) and/or used by the sensor module 102, the computing device 104, and/or the operational systems 106 to generate other data metrics and parameters. The sensors may be any type of sensor, for example, acoustic, electric, environmental, optical, imaging, light, pressure, force, thermal, temperature, proximity, gyroscope, and accelerometers, among others. While the first optical sensor 204 and the second optical sensor 206 are described more or fewer sensors may be utilized.

The computing device 104 includes a processor 116, a memory 118, a data store 120, and a communication interface 122, which are each operably connected for computer communication via a bus 108 and/or other wired and wireless technologies. The communication interface 122 provides software and hardware to facilitate data input and output between the components of the computing device 104 and other components, networks, and data sources, which will be described herein. Additionally, the computing device 104 also includes an identification module 124, a preference distribution module 126, a joint state module 128, and a path planning module 130 for game theoric path planning for social navigation facilitated by the components of the operating environment 100.

The identification module 124, the preference distribution module 126, the joint state module 128, and/or the path planning module 130 may implemented via the processor 116. The identification module 124, the preference distribution module 126, the joint state module 128, and/or the path planning module 130 may be an artificial neural network that act as a framework for machine learning, including deep learning. For example, the identification module 124, the preference distribution module 126, the joint state module 128, and/or the path planning module 130 may be a convolution neural network (CNN). In another embodiment, the identification module 124, the preference distribution module 126, the joint state module 128, and/or the path planning module 130 may further include or implement concatenator, a deep neural network (DNN), a recurrent neural network (RNN), a 3D Convolutional Neural Network (3DCNN) and/or Convolutional Long-Short Term Memory (ConvLSTM). The identification module 124, the preference distribution module 126, the joint state module 128, and/or the path planning module 130 may include an input layer, an output layer, and one or more hidden layers, which may be convolutional filters. In another embodiment, the identification module 124, the preference distribution module 126, the joint state module 128, and/or the path planning module 130 may include one or more neural networks.

The computing device 104 is also operably connected for computer communication (e.g., via the bus 108 and/or the communication interface 122) to one or more operational systems 106. The operational systems 106 may include, but are not limited to, any automatic or manual systems that may be used to enhance the ego agent 202, operation, manipulation of objects, and/or propulsion. The operational systems 106 may dependent on the implementation. For example, the operational system may include an execution module 132. The execution module 132 monitors, analyses, operates the device to some degree. As another example, in a vehicular embodiment, the operational systems 106 may include a brake system (not shown), that monitors, analyses, and calculates braking information and facilitates features like anti-lock brake system, a brake assist system, and an automatic brake prefill system in a vehicular environment such as a roadway, intersection highway, etc. As yet another example, the execution module 132 may cause the ego agent 202 to navigate the agent environment having one or more biological agents, such as the first agent 208 and the second agent 210. The operational systems 106 also include and/or are operably connected for computer communication to the sensor module 102. For example, one or more sensors of the sensor module 102 may be incorporated with the execution module 132 to monitor characteristics of the environment or the ego agent 202.

The sensor module 102, the computing device 104, and/or the operational systems 106 are also operatively connected for computer communication to the network 134. The network 134 is, for example, a data network, the Internet, a wide area network (WAN) or a local area (LAN) network. The network 134 serves as a communication medium to various remote devices (e.g., databases, web servers, remote servers, application servers, intermediary servers, client machines, and other portable devices, among others). Detailed embodiments describing exemplary methods using the system and network configuration for game theoric path planning for social navigation discussed above will now be discussed in detail.

### II. Methods for Game Theoric Path Planning

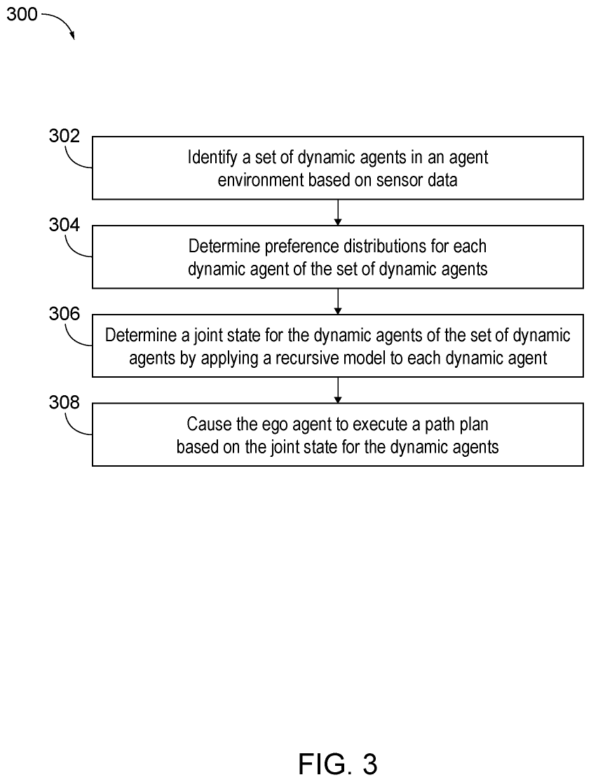

Referring now to FIG. 3, a method 300 for game theoric path planning for social navigation will now be described according to an exemplary embodiment. FIG. 3 will also be described with reference to FIGS. 1, 2, 4, and 5. For simplicity, the method 300 will be described as a sequence of elements, but it is understood that the elements of the method 300 may be organized into different architectures, blocks, stages, and/or processes.

At block 302, the method 300 includes the identification module 124 identifying a set of dynamic agents in an agent environment based on sensor data 110 from one or more agent sensors of an ego agent 202 such as the image data 112 and/or the depth data 114. Turning to FIG. 2, the dynamic agents include the ego agent 202 and the other agents 208-214 are entities moving in the agent environment 200. The dynamic agents include the ego agent 202. Information about the ego agent 202 may be determined based on agent systems of the execution module 132. The ego kinematic data may be stored in the memory 118 and/or the data store 120 including current ego kinematic data and historical ego kinematic data regarding the position, orientation, trajectory, velocity, and acceleration, among others.

The identification module 124 may identify the other agents 208-214 based on the movement, path planning, and/or capability identify the position of the other agents 208-214. The other agents 208-214 may be biological entities (humans, animals, insects), vehicles, robots, etc. The other agents 208-214 may be identified based on sensor data 110 including, image data 112, the depth data 114, motion data, and physiological data, among others. In this manner, the identification module 124 may detect or identify one or more of the entities, objects, obstacles, hazards, etc. based on kinematic data including a position or a location associated with the other agents 208-214, such as a lane location, coordinates, position, orientation, size, trajectory, velocity, acceleration, etc.

The sensor data 110 may be received iteratively and include previous kinematic data from a first time and current kinematic data from a second time after the first time. For example, the identification module 124 may determine a first location of the first agent 208 at a first time, and later at a second time, the identification module 124 may determine a second location of the first agent 208. In this manner, the identification module may determine historical kinematic data for one or more of the dynamic agents. While position is described, the identification module 124 may detect the kinematic data iteratively for a number of time steps including the first time, the second time, a third time, and so on.

The identification module 124 may also model the characteristics and attributes of the other agents 208-214 relative to the ego agent 202 as relative kinematics. The relative kinematics may include, for example, an agent identification, how the trajectories of the other agents 208-214 coincide with the path planning of the ego agent 202, speeds of the other agents 208-214 relative to the ego agent 202, distances of the other agents 208-214 from the ego agent 202, a bearing or direction of travel of the other agents 208-214 relative to the ego agent 202, acceleration of the other agents 208-214 relative to the ego agent 202, etc. Furthermore, the identification module 124 may determine attributes or characteristics of the other agents 208-214 relative to one another.

In one or more embodiments, the identification module 124 may identify features of the agent environment 200, such as white lines and hard shoulders of a roadway. In another embodiment, the identification module 124 may identify infrastructure of the agent environment 200. Further, the identification module 124 may identify or classify an agent of the other agents 208-214 as different types of agents, for example, a pedestrian, vehicle, a cyclist, a robot, etc. The different types may be based on the speed at which the agent moves, the size of the other agents 208-214, and/or other sensor data 110.

The sensor module 102 receives sensor data 110. The sensor data 110 may be received from the first optical sensor 204, the second optical sensor 206, remote devices (e.g., via the bus 108 and/or the communications interface 122), and/or a biological entity. The sensor data 110 may include a video sequence or a series of images, user inputs, and/or data from the operational systems 106, such as data from a Controller Area Network (CAN) bus including as pedal pressure, steer angle, etc. The sensor data 110 may include one or more radar units, image capture components, sensors, cameras, gyroscopes, accelerometers, scanners (e.g., 2-D scanners or 3-D scanners), or other measurement components. In some embodiments, the sensor data 110 is augmented as additional sensor data from other sources is received. For example, the data from the CAN bus may be augmented by information the other agents 208-214, the types of agent, and image/video data, among others.

At block 304, the method 300 includes the preference distribution module 126 determining preference distributions for each dynamic agent of the set of dynamic agents. As discussed above, the set of dynamic agents include the ego agent 202 and the other agents 208-214. A preference distribution for a dynamic agent of the set of dynamic agents is a probability distribution of a set of candidate trajectories to a goal state that do not account for agent interference of other dynamic agents of the set of dynamic agents 202, 208-214.

The preference distribution module 126 determines the preference distribution for the set of dynamic agents 202, 208-214. Given N dynamic agents 202, 208-214, including the ego agent 202 and the other agents 208-214, in the agent environment 200. The indices may include i={1, 2, . . . , N} for the dynamic agents 202, 208-214 with index 1 being reserved for the ego agent 202. The agent environment 200 is denoted as χ⊂ [symbol] ² that describe, for example, the planar positions of the set of dynamic agents 202, 208-214. The trajectory of an agent i is denoted as a continuous function of time sᵢ: [symbol] ⁺ [symbol] χ, which maps time to the agent's state at that moment. The space of all possible trajectories is trajectory space, denoted as [symbol] .

Each agent's prior intent to reach a goal state before interaction is denoted as pᵢ′(s). The prior intent represents the agent's intent without the presence of other agents and is based on the sensor data 110 for the set of dynamic agents 202, 208-214. The preference distribution module 126 may construct a prior intent pᵢ′(s) of the agent i as Gaussian process that is a distribution over trajectories. In this manner, a preference distribution for a dynamic agent of the set of dynamic agents is a probability distribution of a set of candidate trajectories to the goal state that do not account for agent interference of other dynamic agents of the set of dynamic agents.

Thus, the preference distribution reflects the behavior of an agent i toward the goal state without accounting for other objects, such as any other agents, in the agent environment 200. Accordingly, the preference distribution pᵢ′(s) does not reflect interference avoidance behavior of an agent. The Gaussian process [symbol] may be characterized by a mean function m(t) and a covariance kernel K(t, t′):

s(t)˜ [symbol] (m(t)K(t,t′))

Since the trajectories are module as a mapping from time to agent state, the Gaussian processes are stochastic processes. The mean function may be a constant velocity model. Accordingly, the characterization of the Gaussian processes as the prior intents is given by the kernel function. The temporal correlation is the correlation between the agent states at different times. Based on the marginal property of Gaussian processes, given a [symbol] denoted as [symbol] (m(t)K(t, t′)), the marginal distribution of the [symbol] at any two time steps, t, t′, such as from the first time, t₁, to the second time, t₂, is a finite-dimensional Gaussian distribution as:

$$[ \begin{matrix}s ( {t}_{1} ) \\ s ( {t}_{2} )\end{matrix} ] ∼ 𝒩 ( [ \begin{matrix}m ( {t}_{1} ) \\ m ( {t}_{2} )\end{matrix} ] , [ \begin{matrix}K ( {t}_{1} , {t}_{1} ) & K ( {t}_{1} , {t}_{2} ) \\ K ( {t}_{2} , {t}_{1} ) & K ( {t}_{2} , {t}_{2} )\end{matrix} ] ) = 𝒩 ( [ \begin{matrix}{m}_{1} \\ {m}_{2}\end{matrix} ] , [ \begin{matrix}{K}_{11} & {K}_{12} \\ {K}_{21} & {K}_{22}\end{matrix} ] )$$

The covariance matrix entries K₁₁ and K₂₂ determine the uncertainty of the agent state at the first time, t₁, and the second time, t₂. Based on the conditional property of multivariate Gaussian distribution, the off-diagonal entry K₁₂=K₂₁ represents variance of the Gaussian distribution of the state x₂=s(t₂) at the second time, t₂, conditioned on the state x₁=x(t₁) at the first time, t₁.

$${x}_{2} ∼ 𝒩 ( {m}_{1} + {K}_{12} {K}_{22}^{- 1} ( {x}_{1} - {m}_{2} ) {K}_{11} - {K}_{12} {K}_{22}^{- 1} {K}_{21} )$$

The temporal covariance kernel function K(t, t′) is the correlation between two times, such as the first time, t₁, and the second time, t₂, as:

$$c ( {t}_{1} , {t}_{2} ) = K ( {t}_{1} , {t}_{1} ) - K ( {t}_{1} , {t}_{2} ) {K ( {t}_{2} , {t}_{2} )}^{- 1} K ( {t}_{2} , {t}_{1} )$$

In this manner, the Gaussian Process mean may be a constant velocity model and the covariance model in [symbol] regression characterizes the uncertainty of the prior intents.

The probabilistic belief for each agent of the set of dynamic agents 202, 208-214 over each agent's intended future trajectory. Accordingly, an agent i's intent belief as pᵢ(s): [symbol] ₀⁺. Since the preference distribution is a probability distribution it satisfies:

$${\int }_{} {p}_{i} ( s ) d s = 1 , ∀ i ∈$$

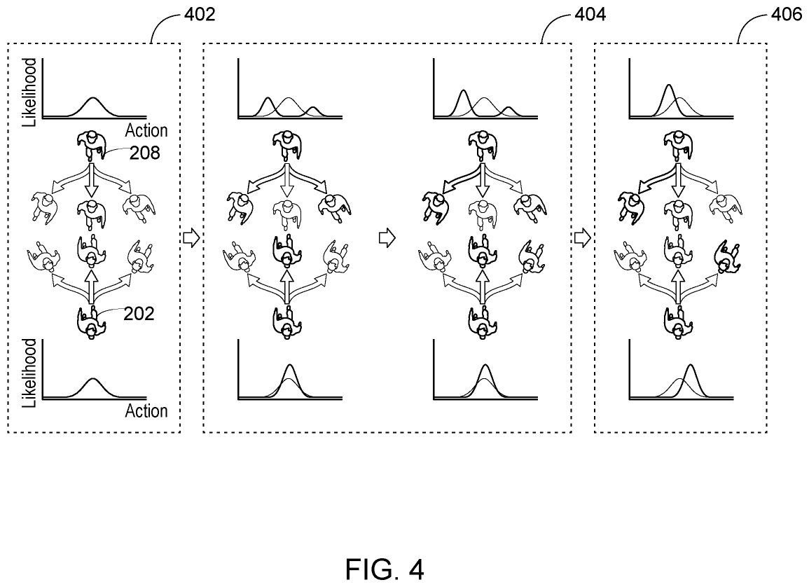

Turning to FIG. 4, in a first stage 402, the preference distribution reflects the intent of an agent i as a likelihood of a number of possible actions based on the prior intents, here shown with respect to the ego agent 202 and the first agent 208. Here, the ego agent 202 and the first agent 208 may be attempting to move through an agent environment 200, such as a hallway. Accordingly, in the first stage 402, the prior beliefs, as preference distributions, of both agents' intents are established, which are two Gaussian distributions with the mean being going straight forward through the agent environment 200.

At block 306, the method 300 includes the joint state module 128 determining a joint state for the dynamic agents 202, 208-214 of the set of dynamic agents 202, 208-214 by applying a recursive model to each dynamic agent to calculate a trajectory likelihood based on an expected interference risk of a candidate trajectory of a preference distribution. The joint state for the set of dynamic agents minimizes deviations from the goal state for each dynamic agent and minimizes the expected interference risk. The interference risk is the probability that following a particular trajectory will result in two or more agents attempting to occupy the same region of space. Occupying the same region of space may cause the agents to contact with one another in an undesirable way or violate social norms (e.g., standing too close to another agent, passing too close to another agent, etc.) with other agents.

An interference risk is defined as a function r(s₁, s₂): [symbol] × [symbol] ₀⁺, which evaluate the interference risk between two trajectories. Given the posterior belief pᵢ of an agent as the expected interference risk of a trajectory s is defined as:

$${𝔼}_{{p}_{i} , {p}_{j}} [ r ] ( s ) = {\int }_{} r ( s , ξ ) {p}_{i} ( ξ ) d ξ$$

Accordingly, the joint expected interference risk between two agents, such as the ego agent 202 and the first agent 208, is defined as the joint expectation of interference risk with respect to their posterior beliefs pᵢ and pⱼ is given by:

$${𝔼}_{{p}_{i} , {p}_{j}} [ r ] = {\int }_{} {\int }_{} {p}_{i} ( {s}_{i} ) {p}_{j} ( {s}_{j} ) r ( {s}_{i} , {s}_{j} ) d {s}_{i} d {s}_{j}$$

The recursive model, given the posterior belief of an agent j the trajectory likelihood of measuring an agent i following a trajectory s is defined as:

z(s|pᵢ)=exp( [symbol] pⱼ[r](s))

The trajectory likelihood is an inverse exponential of the joint expectation value. Accordingly, given the preference distribution pᵢ′(s) of the agent i and the posterior belief pⱼ(s) of the agent j, the joint state module 128 determines the joint state for two agents as:

$$\begin{matrix}{p}_{i} ( {s}_{i} ) = η \cdot {p}_{i}^{′} ( s ) \cdot z ( s \vert {p}_{i} ) \\ = η \cdot {p}_{i}^{′} ( s ) \cdot exp ( - {𝔼}_{{p}_{j}} [ r ] ( s ) )\end{matrix}$$

η is the normalization term. In this manner, the posterior belief pᵢ is based on the preference distribution pᵢ′(s) as applied to the recursive model for the agent i denoted as z(s|pᵢ). The recursive model is based on a Bayes' Rule for conditional probability.

The joint state module 128 may determine the joint state for each of the other agent 208-214 other than the ego agent 202. In this example, the ego agent 202, represented by the index i, and the other agents 208-214 are represented by the index /i. Then the trajectory likelihood of the ego agent 202 following a trajectory s is defined as:

$$z ( s \vert {p}_{/ i} ) = exp ( - {𝔼}_{{p}_{/ i}} [ r ] ( s ) ) \\ {p}_{/ i} ( s ) = \overline{{\sum }_{J ∈ {N}_{/ l}} {p}_{{}_{J}} ( s )}$$

Where Σ̅ denotes an average sum.

Given the prior intent pᵢ′(s) of the agent i and the posterior belief p_{/i}(s) of the other agents 208-214, the joint state module 128 determines the joint state for all of the dynamic agents 202, 208-214:

$$\begin{matrix}{p}_{i} ( {s}_{i} ) = η \cdot {p}_{i}^{′} ( s ) \cdot z ( s \vert {p}_{/ i} ) \\ = η \cdot {p}_{i}^{′} ( s ) \cdot exp ( - {𝔼}_{{p}_{/ i}} [ r ] ( s ) )\end{matrix}$$

Accordingly, the trajectory likelihood z(s|pᵢ) is calculated for each candidate trajectory s of the preference distribution pᵢ′ for each dynamic agent. By applying the recursive model, such as the Bayesian belief updating scheme based on a Bayes' Rule for conditional probability, the trajectory likelihoods for each trajectory in the preference distribution define costs for unilateral movements associated with the trajectories of the preference distribution pᵢ′ for that agent, here the agent denoted by i, of the set of dynamic agents. The trajectory likelihoods for each candidate trajectory of the candidate trajectories of the preference distribution define a probability distribution of posterior beliefs of the corresponding agent. The joint state is defined by the trajectories for the dynamic agents that correspond to the minimal costs for the unilateral movements in the joint state.

Turning back to FIG. 4, in a second stage 404, the recursive model may be used iteratively to model the implicit negotiation in the belief space between the agents, here the ego agent 202 and the first agent 208. The posterior beliefs of both agents' intents converge to the Nash equilibrium, where the belief of the ego agent 202 shows a strong preference for going right, and the belief of the first agent 208 is also to move right. In this manner, in the second stage 404, the joint state module 128 determines a joint state for the dynamic agents 202, 208-214 that minimizes deviations from the goal state for each dynamic agent, in the example of FIG. 4 moving straight through a hallway, while also minimizing the expected interference risk of the dynamic agents 202, 208-214 trying to occupy the same region and, for example, making undesirable contact with one another. Thus, in the joint state, the costs are minimized for the unilateral movements of the dynamic agents 202, 208-214.

The joint state module 128 may determine the joint state iteratively for a number of time steps k, until a convergence criterion is satisfied. The convergence criterion is a joint probability threshold of agent interference. For example, the convergence criterion may be joint probability of interference between at least two agents equal to or less than one percent. The iterative application of the recursive model may be defined by a multi-agent social navigation algorithm:

| | |
|---|---|
| 1: | procedure MULTIAGENTSOCIALNAV(p′ᵢ, . . . p′_{N}) |
| 2: | k < 0 [symbol] k is the negotiation step. |
| 3: | for i ∈ [1, N] do |
| 4: | pᵢ^{[k]} (s) ← p′ᵢ(s) |
| 5: | end for |
| 6: | while convergence criterion not met do |
| 7: | for i ∈ [1, N] do |

| | |
|---|---|
| 8: | ${p}_{/ i}^{[ k ]} ← \frac{1}{N - 1} [ {\sum }_{j < i} {p}_{j}^{[ k + 1 \}} + {\sum }_{j > i} {p}_{j}^{[ k \}} ]$ |
| 9: | p_{/i}^{[k + 1]} ← η · p′ᵢ · z (s\|p_{/i}^{[k]}) |
| 10: | end for |
| 11: | k ← k + 1 |
| 12: | end while |
| 13: | return p₁^{[k]}, . . . p_{N}^{[k]} |
| 14: | end procedure |

The resulting joint state for the dynamic agents 202, 208-214 is a Nash equilibrium, which is a global Nash equilibrium of a general-sum game that results in, as discussed above, a lower-bounded reduction of the joint expected interference risk among the dynamic agent 202, 208-214. For example, with N dynamic agents, the ego agent's decision is a probability distribution of posterior beliefs denoted as pᵢ(sᵢ). The objective of the ego agent 202 denoted as i is:

$${J}_{i} ( {p}_{1} , … , {p}_{N} ) = {𝔼}_{{p}_{i} , {p}_{/ i}} [ r ] + D ( {p}_{i} \vert \vert {p}_{i}^{′} ) \\ {p}_{/ i} ( s ) = \overline{{\sum }_{J ∈ {N}_{/ l}} {p}_{{}_{J}} ( s )}$$

Here, D (⋅∥⋅) is the Kullback-Leibler (KL)-divergence between two distributions and the preference distribution, pᵢ′, is determinable and based on the sensor data 110.

A path planning module 130 may calculate an executable trajectory for an agent, such as an ego trajectory for the ego agent 202 from the joint state. The executable trajectory may define the path of the agent through the agent environment 200. The path planning module 130 may further define future kinematics for traversing the executable trajectory according to the joint state. For example, the path planning module 130 may determine that the path should be traversed at five miles per hour. The executable trajectory may order executable instructions in a sequential order.

At block 308, the method 300 includes the execution module 132 causing the ego agent 202 to execute the executable trajectory based on the joint state for the dynamic agents 202, 208-214. For example, the execution module 132 may provide operational data to agent systems of the ego agent 202, such as the steering system, that cause the ego agent 202 to traverse the agent environment 200 according to the ego trajectory of the joint state. For example, turning back to FIG. 4, in a third stage 406, the execution module 132 may cause the ego agent 202 to move to the right in accordance with the ego trajectory rather than moving straight forward to minimize the risk of undesirable contact with the first agent 208.

In this manner the systems and methods for game theoric path planning for social navigation leads to the Nash equilibrium of a general-sum game in the belief space. For example, where the recursive model is based on a Bayes' rule, this Bayes' rule Nash equilibrium is an inference model for an agent to assess the impact from its action to other agents' actions, such as humans, while taking into account the uncertainty and risk-awareness in human behavior. The use of recursive model paves ways to efficient approximation of Bayes' rule Nash equilibrium for real-time crowd navigation with less processing power.

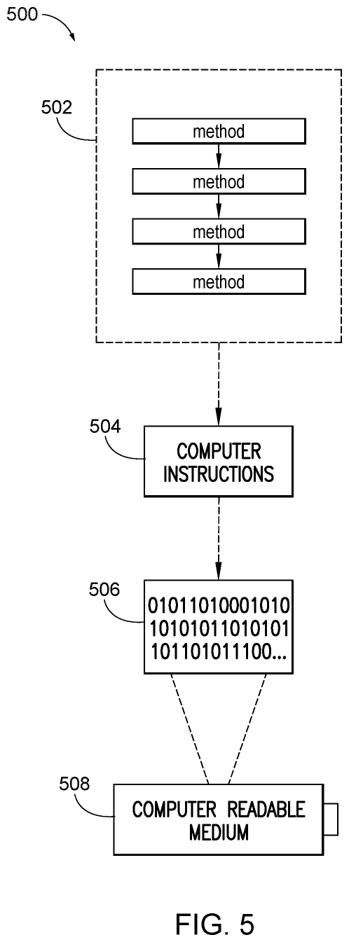

Still another aspect involves a computer-readable medium including processor-executable instructions configured to implement one aspect of the techniques presented herein. An aspect of a computer-readable medium or a computer-readable device devised in these ways is illustrated in FIG. 5, wherein an implementation 500 includes a computer-readable medium 508, such as a CD-R, DVD-R, flash drive, a platter of a hard disk drive, etc., on which is encoded computer-readable data 506. This encoded computer-readable data 506, such as binary data including a plurality of zero's and one's as shown in 506, in turn includes a set of processor-executable computer instructions 504 configured to operate according to one or more of the principles set forth herein.

In this implementation 500, the processor-executable computer instructions 504 may be configured to perform a method 502, such as the method 300 of FIG. 3. In another aspect, the processor-executable computer instructions 504 may be configured to implement a system, such as the operating environment 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A computer-implemented method for game theoric path planning for social navigation, the method comprising:
identifying a set of dynamic agents in an agent environment based on sensor data from one or more agent sensors of an ego agent;
determining preference distributions for each dynamic agent of the set of dynamic agents, wherein a preference distribution for a dynamic agent of the set of dynamic agents is a probability distribution of a set of candidate trajectories to a goal state that do not account for agent interference of other dynamic agents of the set of dynamic agents;
determining a joint state for the dynamic agents of the set of dynamic agents by applying a recursive model to each dynamic agent to calculate a trajectory likelihood based on an expected interference risk of a candidate trajectory and the preference distributions, wherein the joint state for the set of dynamic agents minimizes deviations from the goal state for each dynamic agent and minimizes the expected interference risk; and
causing the ego agent to execute a path plan based on the joint state for the dynamic agents.

2. The computer-implemented method for game theoric path planning of claim 1, wherein the set of dynamic agents includes the ego agent and a number of biological entities.

3. The computer-implemented method for game theoric path planning of claim 1, wherein the trajectory likelihood is an inverse exponential.

4. The computer-implemented method for game theoric path planning of claim 1, wherein the recursive model is applied iteratively until a convergence criterion is satisfied, and wherein the convergence criterion is a joint probability threshold of agent interference.

5. The computer-implemented method for game theoric path planning of claim 1, wherein the trajectory likelihood is calculated for each candidate trajectory of the preference distribution for each dynamic agent and defines costs for unilateral movements for a corresponding agent of the set of dynamic agents, and wherein trajectory likelihoods for each candidate trajectory define a probability distribution of posterior beliefs of the corresponding agent.

6. The computer-implemented method for game theoric path planning of claim 5, wherein the costs are minimized for the unilateral movements in the joint state.

7. The computer-implemented method for game theoric path planning of claim 1, wherein the recursive model is based on a Bayes' Rule for conditional probability, and wherein the joint state is a Nash equilibrium.

8. A system for game theoric path planning for social navigation, comprising:
a processor, and
a memory storing instructions that when executed by the processor cause the processor to:
identify a set of dynamic agents in an agent environment based on sensor data from one or more agent sensors of an ego agent;
determine preference distributions for each dynamic agent of the set of dynamic agents, wherein a preference distribution for a dynamic agent of the set of dynamic agents is a probability distribution of a set of candidate trajectories to a goal state that do not account for agent interference of other dynamic agents of the set of dynamic agents;
determine a joint state for the dynamic agents of the set of dynamic agents by applying a recursive model to each dynamic agent to calculate a trajectory likelihood based on an expected interference risk of a candidate trajectory and the preference distributions, wherein the joint state for the set of dynamic agents minimizes deviations from the goal state for each dynamic agent and minimizes the expected interference risk; and
cause the ego agent to execute a path plan based on the joint state for the dynamic agents.

9. The system for game theoric path planning of claim 8, wherein the set of dynamic agents includes the ego agent and a number of biological entities.

10. The system for game theoric path planning of claim 8, wherein the trajectory likelihood is an inverse exponential.

11. The system for game theoric path planning of claim 8, wherein the recursive model is applied iteratively until a convergence criterion is satisfied, and wherein the convergence criterion is a joint probability threshold of agent interference.

12. The system for game theoric path planning of claim 8, wherein the trajectory likelihood is calculated for each candidate trajectory of the preference distribution for each dynamic agent and defines costs for unilateral movements for a corresponding agent of the set of dynamic agents, and wherein trajectory likelihoods for each candidate trajectory define a probability distribution of posterior beliefs of the corresponding agent.

13. The system for game theoric path planning of claim 12, wherein the costs are minimized for the unilateral movements in the joint state.

14. The system for game theoric path planning of claim 8, wherein the recursive model is based on a Bayes' Rule for conditional probability, and wherein the joint state is a Nash equilibrium.

15. A non-transitory computer readable storage medium storing instructions that when executed by a computer having a processor to perform a method for game theoric path planning for social navigation, the method comprising:
identifying a set of dynamic agents in an agent environment based on sensor data from one or more agent sensors of an ego agent;
determining preference distributions for each dynamic agent of the set of dynamic agents, wherein a preference distribution for a dynamic agent of the set of dynamic agents is a probability distribution of a set of candidate trajectories to a goal state that do not account for agent interference of other dynamic agents of the set of dynamic agents;
determining a joint state for the dynamic agents of the set of dynamic agents by applying a recursive model to each dynamic agent to calculate a trajectory likelihood based on an expected interference risk of a candidate trajectory and the preference distributions, wherein the joint state for the set of dynamic agents minimizes deviations from the goal state for each dynamic agent and minimizes the expected interference risk; and
causing the ego agent to execute a path plan based on the joint state for the dynamic agents.

16. The non-transitory computer readable storage medium of claim 15, wherein the set of dynamic agents includes the ego agent and a number of biological entities.

17. The non-transitory computer readable storage medium of claim 15, wherein the trajectory likelihood is an inverse exponential.

18. The non-transitory computer readable storage medium of claim 15, wherein the recursive model is applied iteratively until a convergence criterion is satisfied, and wherein the convergence criterion is a joint probability threshold of agent interference.

19. The non-transitory computer readable storage medium of claim 15, wherein the trajectory likelihood is calculated for each candidate trajectory of the preference distribution for each dynamic agent and defines costs for unilateral movements for a corresponding agent of the set of dynamic agents, wherein trajectory likelihoods for each candidate trajectory define a probability distribution of posterior beliefs of the corresponding agent, and wherein the costs are minimized for the unilateral movements in the joint state.

20. The non-transitory computer readable storage medium of claim 15, wherein the recursive model is based on a Bayes' Rule for conditional probability, and wherein the joint state is a Nash equilibrium.
